(19) United States
(12) Patent Application Publication
(10) Pub. No.: US 2009/0129990 A1
(43) Pub. Date: May 21, 2009

(54) RACK FOR SAMPLE CONTAINERS FOR CLINICAL ANALYZER

(75) Inventors: HIDESUKE KOKAWA, SUNNYVALE, CA (US); RICHARD G. KENDALL, SAN JOSE, CA (US)

Correspondence Address: PAUL D. YASGER;ABBOTT LABORATORIES, 100 ABBOTT PARK ROAD, DEPT. 377/AP6A, ABBOTT PARK, IL, 60064-6008, US

(73) Assignee: ABBOTT LABORATORIES, Abbott Park, IL (US)

(21) Appl. No.: 11/941,151

(22) Filed: Nov. 16, 2007

(51) Int. Cl. B01L 9/00; G01N 37/00

(52) U.S. Cl. 422/104; 702/82

(57) ABSTRACT

A device for enabling the user of a clinical analyzer, such as, for example, an automated clinical analyzer, e.g., an automated hematology analyzer, to identify samples that require additional processing subsequent to an initial run through the clinical analyzer. The device can also indicate the location of sample containers to assist the user in finding a sample from a sample retention area. The device comprises a rack comprising a plurality of receptacles, each receptacle having a recessed area for holding a sample container, e.g., a sample tube. Each receptacle is associated with an indicator for signaling when a sample container in a given receptacle area requires additional processing.

### BACKGROUND OF THE INVENTION

1. Field of the Invention

This invention relates to sample racks for clinical analyzers, and, more particularly, sample racks for automated clinical analyzers.

2. Discussion of the Art

Processing of biological samples after they are analyzed by means of an automated clinical analyzer contributes a significant amount of labor for users of the automated clinical analyzer. Rules based on decision-making software, such as the Abbott Accelerator DM product, improve processing of biological samples after they are analyzed by automating the process of deciding which samples require addition testing, such as, for example, smear review. However, the Abbott Accelerator DM product does not improve the ability of a user to physically identify sample containers containing the biological sample in need of retesting, nor does it enable the determination of the location in an automated clinical analyzer of a sample container containing the biological sample in need of retesting.

It is common for automated clinical analyzers for in vitro diagnostic testing to employ automated processes for handling biological samples. It is common for sample containers to be held in a sample rack that holds a plurality of sample containers. Sample containers are typically loaded into positions in a sample rack prior to the sample rack being introduced to an automated clinical analyzer. The sample containers remain in the sample rack until the automated clinical analyzer has completed processing, whereupon the sample containers, still in their original positions in the sample rack, are removed from the automated clinical analyzer for subsequent storage or further processing, also known as reprocessing.

Numerous types of reprocessing operations can be performed on biological samples. Examples of such reprocessing operations in the area of hematology include, but are not limited to, (a) the spreading of smears, (b) passing samples through the analyzer a second time to confirm results, and (c) passing samples through the analyzer for additional assays, such as, for example, reticulocyte counting.

The selection of samples for reprocessing subsequent to initial analysis is typically carried out manually by the operator of the analyzer. The process of selecting samples for reprocessing is time-consuming and is often based on a review of the results generated by the analyzer, supplemented by details of the particular patient, examples of which include, but are not limited to, age, sex-related reference ranges, requesting clinician or source, previous results, etc.

Attempts have been made to perform additional testing by means of complex, and, consequently, expensive automation solutions. Examples of these attempts involve the implementation of automated robotics or tracking to permit rules embedded in software to identify samples for retesting followed by automated selection of samples and rerunning of tests. Although these processes have proved to be beneficial in some laboratories, they have tended to be so costly that only the largest of the laboratories can afford the appropriate equipment. Still, the sorting and the selection of samples remains a significant part of the workload for all laboratories, even for a laboratory that carries out a medium volume or a low volume of tests.

Accordingly, it would be desirable to provide a simple and inexpensive product that would enable physical identification of samples that require additional processing, without requiring the sample to be physically picked up by a robotic arm or track.

### SUMMARY OF THE INVENTION

This invention provides a device for enabling the user of a clinical analyzer, such as, for example, an automated clinical analyzer, e.g., an automated hematology analyzer, to identify samples that require additional processing subsequent to an initial run through the clinical analyzer. The device can also indicate the location of sample containers to assist the user in finding a sample from a sample retention area.

The device comprises a rack comprising a plurality of receptacles, each receptacle having a recessed area for holding a sample container, e.g., a sample tube. Each receptacle is associated with an indicator for signaling when a sample container in a given receptacle area requires additional processing.

There are several ways to provide the rack with an indicator that is suitable for carrying out the indicating activities described herein. The rack can employ movable pegs as the indicator. The rack can employ light-emitting diodes or liquid crystal displays as the indicator. The light-emitting diodes can be actuated by such agents as electrical switches and radio frequency transmitters and receivers.

By using the sample rack described herein, the operator of the clinical analyzer does not have to review a data log in order to find the identification indicia of a given sample that may require a rerun assay or a retest. In other words, the operator does not have to search for the given sample in the sample rack. The sample rack itself indicates to the operator which samples, if any, require a rerun assay or a retest.

### BRIEF DESCRIPTION OF THE DRAWINGS

FIG. 1 is a front view in elevation illustrating an automated clinical analyzer, i.e., a hematology analyzer, which can employ the sample rack described herein.

FIG. 2 is a perspective view of a sample rack that is suitable for use in this invention. This sample rack employs a mechanical indicator to identify samples that require additional processing subsequent to an initial run through an automated clinical analyzer.

FIG. 3 is a partial front view in elevation of the sample rack of FIG. 2. FIG. 3 further shows a mechanism for actuating a mechanical indicator in order to identify samples that require additional processing subsequent to an initial run through an automated clinical analyzer. In FIG. 3, positions for receptacles for sample tubes and passageways for mechanical indicators are represented by dashed lines.

FIG. 4 is a perspective view, greatly enlarged, of a mechanical indicator that can be used with the sample rack described in FIG. 2.

FIGS. 5A, 5B, and 5C are perspective views, greatly enlarged, illustrating a mechanical indicator positioned at various indication heights. In FIG. 5A, the mechanical indicator has not been actuated. In FIG. 5B, the mechanical indicator has been elevated to the first level. In FIG. 5C, the mechanical indicator has been elevated to the second level.

FIG. 6 is a front view in elevation illustrating resilient biasing elements for retaining the mechanical indicator is a specified position. In FIG. 6, positions for receptacles for sample tubes and passageways for mechanical indicators are represented by dashed lines.

FIG. 7 is a partial side view, in elevation, of a cross-section taken along line 7-7 illustrating a resilient biasing element for retaining a mechanical indicator in specified positions. In FIG. 7, positions for receptacles for sample tubes and passageways for mechanical indicators are represented by dashed lines.

FIG. 8 is a perspective view of a sample rack that is suitable for use in this invention. This sample rack employs light-emitting diodes to identify samples that require additional processing subsequent to an initial run through an automated clinical analyzer.

FIG. 9 is a partial front view in elevation of the sample rack of FIG. 8. In FIG. 9, sample tubes are represented by dashed lines.

FIG. 10 is a side view in elevation of the sample rack of FIG. 8 and a portion of an automated clinical analyzer that is adjacent to the sample rack. In FIG. 10, sample tubes are represented by dashed lines.

FIG. 11 is a front view in elevation of a portion of the sample rack of FIG. 8 and a portion of an automated clinical analyzer that is adjacent to the sample rack. FIG. 11 illustrates the sample rack as it is approaching the sample aspiration station of the automated clinical analyzer. In FIG. 11, sample tubes are represented by dashed lines.

FIG. 12 is a front view in elevation of a portion of a sample rack of FIG. 8 and a portion of an automated clinical analyzer that is adjacent to the sample rack. FIG. 12 illustrates the sample rack in a position wherein all reed relays can be reset by means of a permanent magnet and a reed switch. In FIG. 12, sample tubes are represented by dashed lines.

FIG. 13 is a front view in elevation of a portion of a sample rack of FIG. 8 and a portion of an automated clinical analyzer that is adjacent to the sample rack. FIG. 13 illustrates the sample rack in a position wherein reed relays are set to a latched state to actuate light-emitting diodes by means of electromagnetic rod(s) and reed relay(s). In FIG. 13, sample tubes are represented by dashed lines.

FIG. 14 is an electric schematic diagram illustrating a reed relay latching circuit, wherein a plurality of light-emitting diodes is shown.

FIG. 15 is an electric schematic diagram illustrating a reed relay latching circuit wherein the reed relay is latched by a relay coil.

FIG. 16 is an electric schematic diagram illustrating a reed relay latching circuit wherein the reed relay is reset by opening a normally closed reed switch by means of a magnet.

FIG. 17 is an electric schematic diagram illustrating a reed relay latching circuit wherein the reed relay is unlatched as the reed switch closes the circuit.

FIG. 18 is a perspective view of a sample rack that is suitable for use in this invention. This sample rack employs light-emitting diodes to identify samples that require additional processing subsequent to an initial run through an automated clinical analyzer.

FIG. 19 is a front view in elevation of the sample rack of FIG. 18. In FIG. 19, positions for electrical and electronic components and positions for receptacles for sample tubes are represented by dashed lines. In addition, the front wall of the sample rack is shown as being partially broken away.

FIG. 20 is a side view in elevation of the sample rack of FIG. 18. In FIG. 20, positions for electrical and electronic components and positions for receptacles for sample tubes are represented by dashed lines.

FIG. 21 is a top plan view of the sample rack of FIG. 18.

FIG. 22 is a bottom plan view of the sample rack of FIG. 18. In FIG. 22, positions for receptacles for sample tubes are represented by dashed lines.

FIG. 23 is a perspective view of a system that can be used with the sample rack described herein. This system employs a dedicated sample rack reader upon which the sample rack is placed in order to read the results of tests performed on an automated clinical analyzer. The dedicated sample rack reader employs a liquid crystal display to identify samples that require additional processing subsequent to an initial run through the automated clinical analyzer.

FIG. 24 is a perspective view of a sample rack that is suitable for use in this invention. This sample rack is intended to be used with a dedicated sample rack reader to identify samples that require additional processing subsequent to an initial run through an automated clinical analyzer.

FIG. 25 is a front view in elevation of the sample rack shown in FIGS. 23 and 24 on the tray of the dedicated sample rack reader shown in FIG. 23. In FIG. 25, positions for electrical and electronic components and positions for receptacles for sample tubes are represented by dashed lines. In addition, the front wall of the sample rack is shown as being partially broken away.

FIG. 26 is a front view in elevation of the sample rack of FIG. 24. In FIG. 26, positions for electrical and electronic components and positions for receptacles for sample tubes are represented by dashed lines. In addition, the front wall of the sample rack is shown as being partially broken away.

FIG. 27 is a side view in elevation of the sample rack of FIG. 24. In FIG. 27, positions for electrical and electronic components and positions for receptacles for sample tubes are represented by dashed lines.

FIG. 28 is a top plan view of the sample rack of FIG. 24.

FIG. 29 is a bottom plan view of the sample rack of FIG. 24. In FIG. 29, positions for electrical and electronic components and positions for receptacles for sample tubes are represented by dashed lines.

### DETAILED DESCRIPTION

As used herein, “light-emitting diode” means a semiconductor diode that emits incoherent narrow-spectrum light when electrically biased in the forward direction of the p-n junction. The effect is a form of electroluminescence. As used herein, the term “liquid crystal display” means a thin, flat display device made up of any number of color or monochrome pixels arrayed in front of a light source or reflector. It is often utilized in battery-powered electronic devices because it uses very small amount of electric power.

As used herein, the expression “radio frequency identification”, or RFID, is a generic term for technologies that use radio waves to automatically identify objects, such as, for example, containers for biological samples and containers for reagents for analyzing biological samples. The most common method of identification is to store a serial number that identifies the object, and perhaps other information relating to the object or contents thereof, on a microchip that is attached to an antenna. The microchip and the antenna together are called a radio frequency identification transponder or a radio frequency identification tag. The antenna enables the microchip to transmit the identification information and other information to a radio frequency identification reader. The radio frequency identification reader converts the radio waves reflected back from the radio frequency identification tag into digital information that can then be passed on to computers that can make use of it.

As used herein, the expression “radio frequency identification system” means a system that comprises a radio frequency identification tag made up of a microchip with an antenna, and a radio frequency identification interrogator or radio frequency identification reader with an antenna. The radio frequency identification reader sends out electromagnetic waves. The tag antenna is tuned to receive these waves. A passive radio frequency identification tag draws power from the field created by the reader and uses it to power the circuits of the microchip. The microchip then modulates the waves that the passive radio frequency identification tag sends back to the radio frequency identification reader, which converts the waves received by the radio frequency identification reader into digital data.

As used herein, microchips in radio frequency identification tags can be “read-write microchips”, “read-only microchips”, or “write once, read many microchips.” In the case of read-write microchips, information can be added to the radio frequency identification tag or existing information can be written over when the radio frequency identification tag is within range of a radio frequency identification reader. Read-write microchips usually have a serial number that cannot be written over. Additional blocks of data can be used to store additional information about the items to which the radio frequency identification tag is attached. These radio frequency identification tags can be locked to prevent overwriting of data or encrypted to prevent the disclosure of proprietary data or disclosure of data that would compromise the privacy of a patient. Read-only microchips have information stored on them during the manufacturing process. The information on them can never be changed. Write once, read many microchips have a serial number written to them once, and that information cannot be overwritten later.

As used herein, the expression “active radio frequency identification tag” means a radio frequency identification transmitter having its own power source, typically a battery. The power source is used to run the microchip's circuitry and to broadcast a signal to a radio frequency identification reader. “Passive radio frequency identification tags” have no battery. Instead, passive radio frequency identification tags draw power from the radio frequency identification reader, which sends out electromagnetic waves that induce a current in the tag's antenna. “Semi-passive tags” use a battery to run the microchip's circuitry, but communicate by drawing power from the radio frequency identification reader. Any of the foregoing types of radio frequency identification tags can be used in the system of this invention.

As used herein, the term “radio frequency identification reader” or “reader” means a device having the function of providing means for communicating with a radio frequency identification tag and facilitating transfer of data to and from a radio frequency identification tag. Functions performed by a radio frequency identification reader can include quite sophisticated signal conditioning, parity error checking, and correction. Once the signal from a radio frequency identification tag has been correctly received and decoded, algorithms can be applied to decide whether the signal is a repeat transmission, and can then instruct the radio frequency identification tag to cease transmitting. This type of interrogation is known as “command response protocol” and is used to circumvent the problem of reading a plurality of radio frequency identification tags in a short space of time. An alternative technique involves the radio frequency identification reader looking for radio frequency identification tags with specific identities, and interrogating them in turn. It is within the scope of this invention to use a single radio frequency identification reader or a plurality of radio frequency identification readers. A radio frequency identification reader can have a single antenna or a plurality of antennas.

As used herein, the symbol “(s)” following the name of an item indicates that one or more of the subject items is intended, depending upon the context. As used, herein, the abbreviation “etc.” means “and other unspecified things of the same class.” The abbreviation “etc.” is used in order to account for identical or substantially identical components in cases where it would be cumbersome to list all of the identical or substantially identical components. For example, if ten (10) pairs of items are employed for a given function, the reciting of the first pair of items, e.g., X1, X2 followed by the abbreviation “etc.” (as in X1, X2, etc.) is intended to account for the first pair of items stated and the nine (9) pairs of items remaining but unstated, i.e., X3, X4; X5, X6; X7, X8; X9, X10; X11, X12; X13, X14; X15, X16; X17, X18; and X19, X20.

In the drawings, like reference numerals are used to identify like parts. For example, the sample rack will have the same reference numeral in any drawing in which it appears.

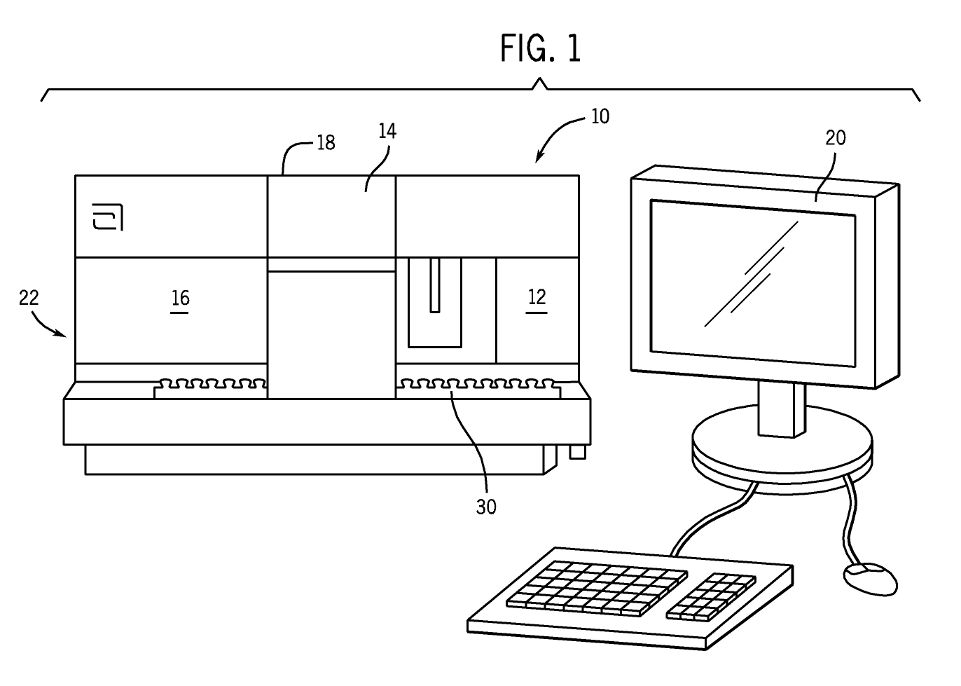

FIG. 1 shows an automated clinical analyzer 10 suitable for use with the sample rack described herein. Although this automated clinical analyzer is a hematology analyzer, it should be noted that use of the sample rack described herein is not limited to hematology analyzers. Automated clinical analyzers contemplated for use with this invention include, but are not limited to, CELL-DYN® Sapphire, CELL-DYN® 3700, and CELL-DYN® 3200. These automated clinical analyzers are commercially available from Abbott Laboratories, Abbott Park, Ill. Descriptions of these analyzers can be found in U.S. Pat. Nos. 5,939,326; 5,891,734; 5,812,419; 5,656,499; 5,631,165; 5,631,730, all of which are incorporated herein by reference. The automated clinical analyzer 10 comprises an input section 12, an analysis section 14, and an output section 16. The analysis section 14 comprises one or more devices for aspirating at least a portion of a sample of blood, diluting the portion of the sample aspirated to the required concentration, and examining the characteristics of the diluted sample by means of optical or electrical measurements or both optical and electrical measurements. The location where samples are aspirated is indicated by the reference numeral 18. The analysis section 14 is electrically connected to a controller/data processing module 20 for controlling the processes of the automated clinical analyzer 10 and processing data obtained from the analysis section 14. The controller/data processing module 20 contains software for controlling the instrument processes and generating a report of the results of the analysis section 14. A sample rack 30 from a plurality of sample racks is introduced to the automated clinical analyzer 10 by way of the input section 12. After the samples in the sample rack 30 are analyzed in the analysis section 14, the sample rack 30 is transferred to the output section 16.

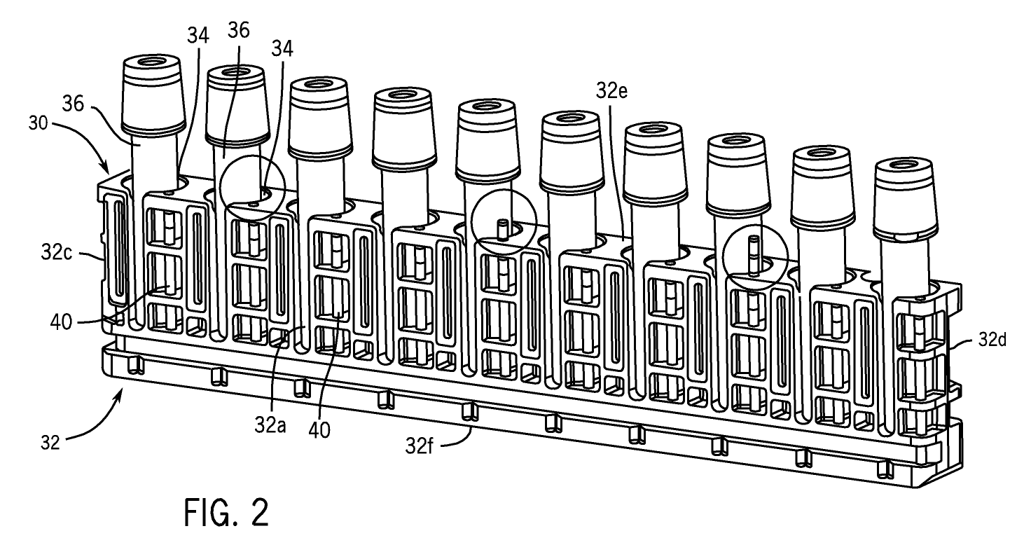

Referring now to FIG. 2, a typical sample rack 30 suitable for use in this invention comprises a body 32 into which is formed a plurality of receptacles 34, each of which receptacles 34 is capable of holding a sample tube 36 in an upright position. The receptacles 34 are arranged in a row. As shown in FIG. 2, the cylindrical shape of each receptacle 34 is substantially similar to the cylindrical shape of the sample tube 36 contained therein. It should be noted that the sample tubes 36 and the receptacles 34 need not be cylindrical in shape. The body 32 of the sample rack 30 has a front wall 32a, a rear wall 32b (not shown in FIG. 2), a first side wall 32c, a second side wall 32d, a top wall 32e, and a bottom wall 32f. On account of limitations resulting from the size of the figures, only a few of the items mentioned herein are designated with reference numerals. It should be noted that items having the same functions, e.g., receptacles 34 and sample tubes 36, are designated by having similar shapes.

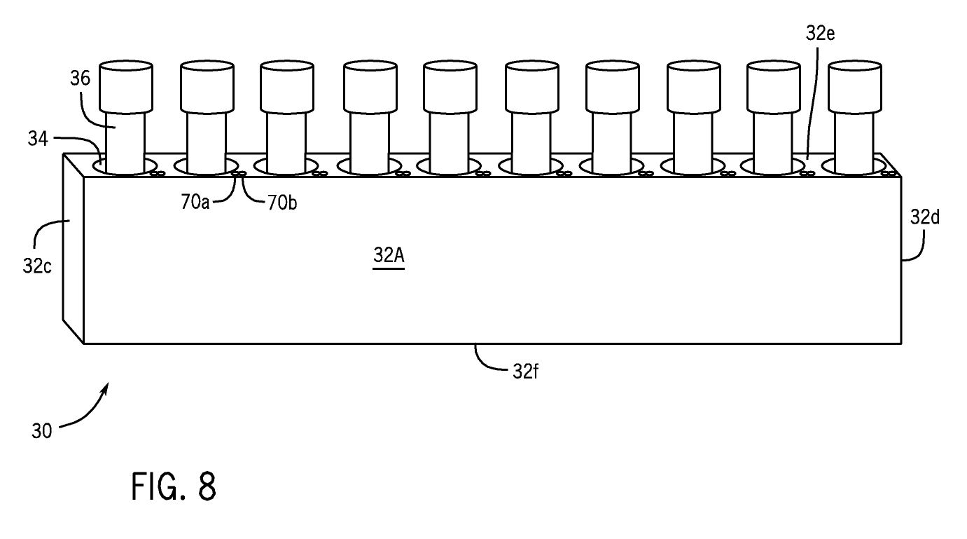

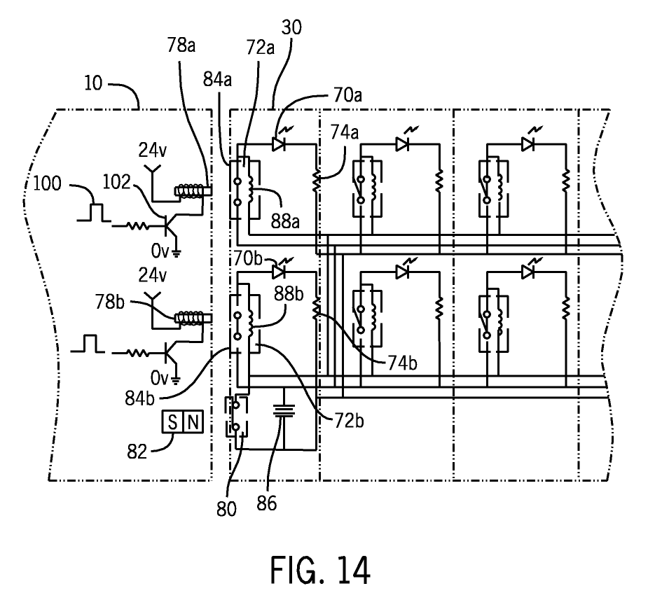

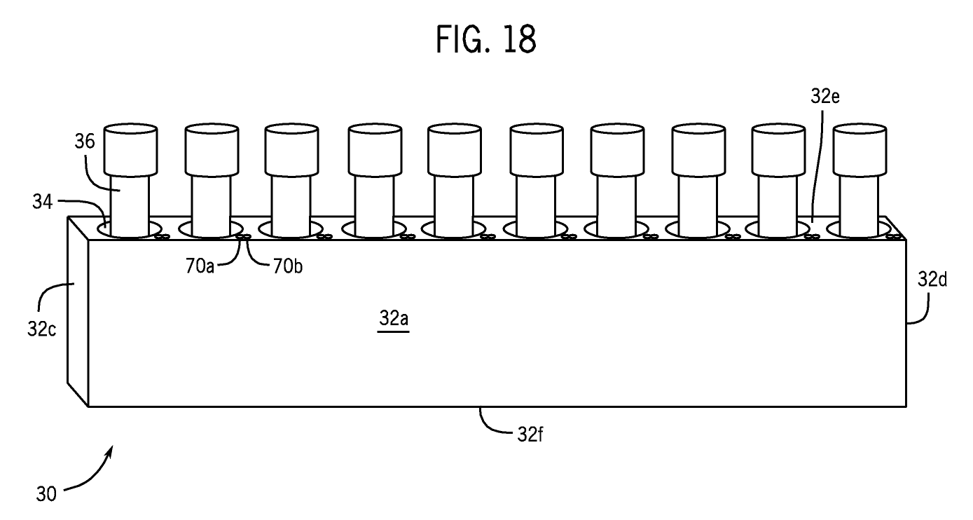

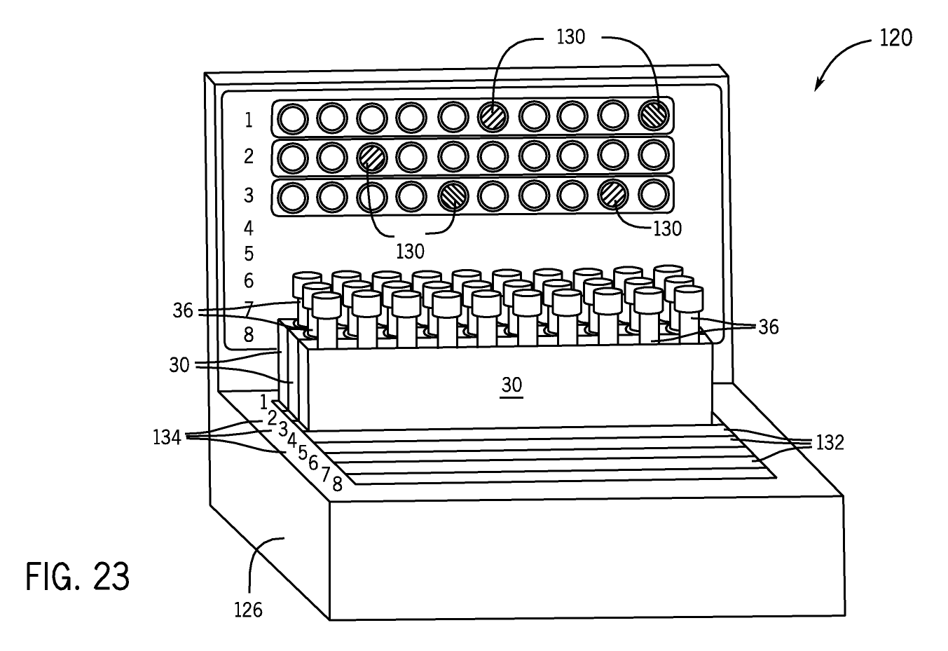

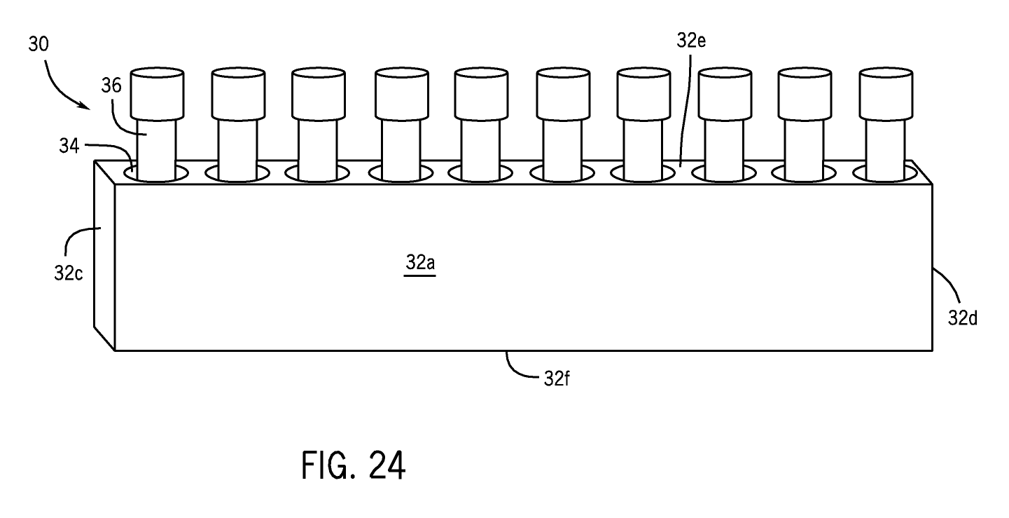

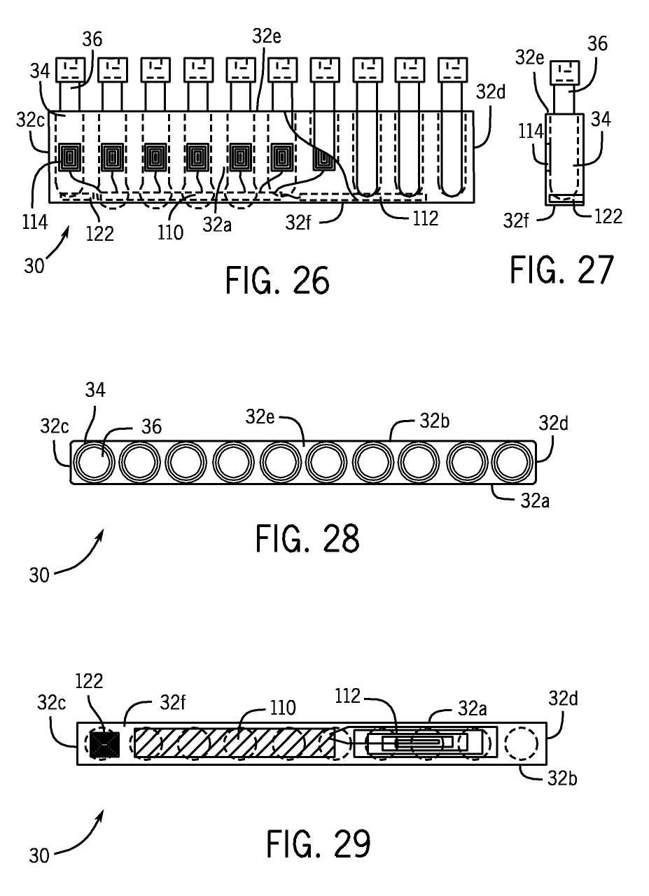

There are numerous ways to provide the sample rack 30 with an indicator that is suitable for carrying out the indicating activities described herein. FIGS. 2, 3, 4, 5A, 5B, 5C, 6, and 7 illustrate a sample rack that employs a movable peg as the indicator. FIGS. 8, 9, 10,11, 12, and 13 illustrate a sample rack that employs light-emitting diodes as the indicator. The light-emitting diodes are actuated by circuits having reed switches and reed relays. Portions of these circuits are shown in FIGS. 14, 15, 16, and 17. FIGS. 18, 19, 20, 21, and 22 illustrate a sample rack that employs light-emitting diodes as the indicator, but these light-emitting diodes can be actuated by radio frequency transmitters and receivers, alternatively referred to herein as transponders. FIGS. 23, 24, 25, 26, 27, 28, and 29 illustrate a sample rack 30 that employs liquid crystal display as the indicator. The liquid crystal display is actuated by a dedicated rack reader upon which the sample rack is placed.

Referring now to FIGS. 2, 3, 4, 5A, 5B, 5C, 6, and 7, the sample rack 30 employs a plurality of indicators 40. Each indicator 40 comprises a movable peg. As shown in FIGS. 2, 3, 6, and 7, there is one movable peg 40 associated with each receptacle 34. In variations of this embodiment, more than one movable peg 40 can be associated with each receptacle 34. However, the use of more than one movable peg 40 associated with a receptacle 34 increases the complexity of the indicator. It is preferred that the movable peg 40 associated with a given receptacle 34 be adjacent to that receptacle.

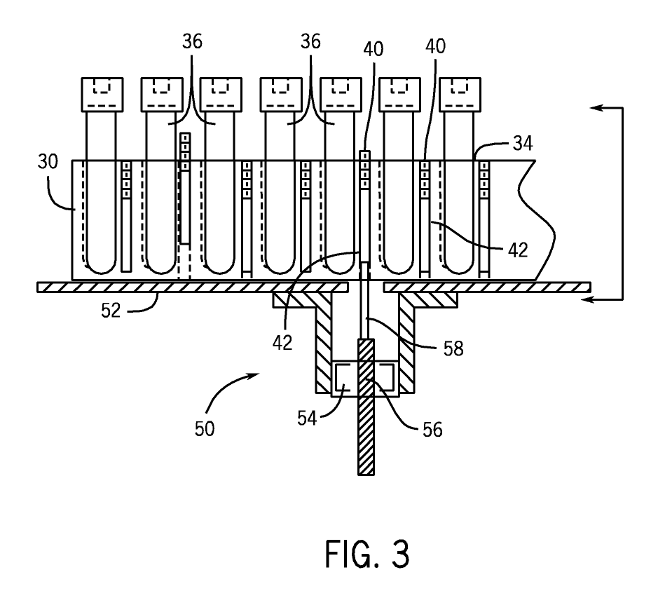

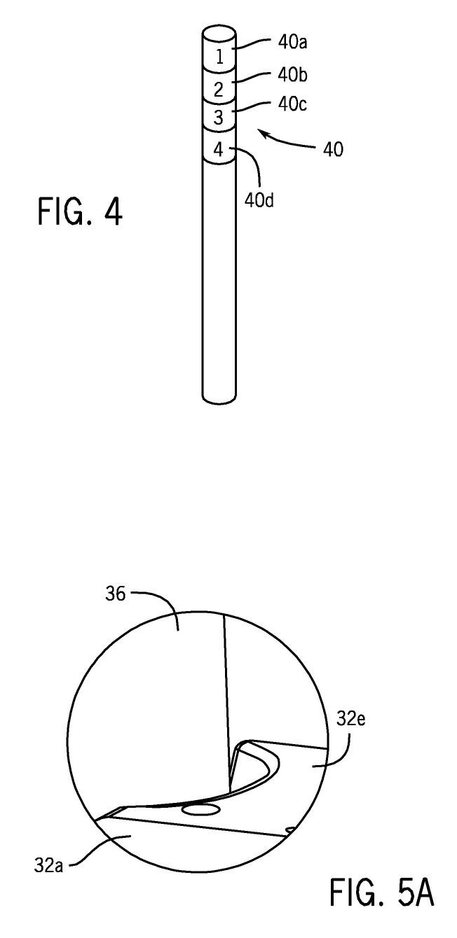

As shown in FIGS. 3 and 4, the movable peg 40 is cylindrical in shape; however, it is not required that the movable peg 40 be cylindrical in shape. The movable peg 40 can assume a variety of forms. In order to position a given movable peg 40 adjacent to a given receptacle 34, a passageway 42 for the given movable peg 40 is formed in the body 32 of the sample rack 30 adjacent to the given receptacle 34. The passageway 42, like the movable peg 40, is also cylindrical in shape; similarly, it is not required that the passageway 42 be cylindrical in shape. As shown in FIG. 4, the movable peg 40 has four cylindrical sections 40a, 40b, 40c, and 40d marked off at one end of the movable peg 40. More cylindrical sections can be used or fewer cylindrical sections can be used. However, as the number of cylindrical sections increase, the complexity of the indicator increases. In order to use the movable peg 40 as an indicator, the movable peg 40 is inserted into the passageway 42. It is preferred that the movable peg 40 be inserted in such a manner that the four cylindrical sections 40a, 40b, 40c, and 40d are closer to the top wall 32a of the body 32 of the sample rack 30 than to the bottom wall 32f of the body 32 of the sample rack 30. The movable peg 40 is inserted into the passageway 42 to such an extent that the cylindrical sections 40a, 40b, 40c, and 40d are not visible to the operator of the automated clinical analyzer 10 prior to use. On account of limitations resulting from the size of the figures, only a limited number, e.g., one, two, or three, of the items mentioned herein are designated with reference numerals on a particular drawing. It should be noted that items having the same functions, e.g., sample tubes 36, receptacles for sample tubes 34, movable pegs 40 and passageways 42, are shown to have identical or substantially similar shapes.

Examples of instructions that can be handled by a system utilizing a movable peg 40 having four sections 40a, 40b, 40c, and 40d include, for example, (1) sample processing completed, (2) blood smear required, (3) sample rerun required, and (4) urgent action required.

A mechanism 50 for moving the indicator peg 40 is positioned under the plate 52 on which the sample rack 30 slides as the samples are passed through the automated clinical analyzer 10. As shown in FIG. 3, the plate 52 is located downstream of the aspiration station 18, which is typically positioned near the center of the analyzer 10, as shown in FIG. 1. The movable peg 40 can be driven by a motor 54, which can be actuated by a signal generated by software and algorithms originating from the controller/data processing module 20 of the automated clinical analyzer 10. The motor 54 can be actuated by an electrical pulse generator (not shown) and motor drive circuits (not shown) mounted on the automated clinical analyzer 10. The electrical pulse generator is operated by means of software, which typically employs an algorithm(s) to generate warning signals for indicating the need for retesting a sample or for other actions, e.g., blood smear required, urgent action required. Upon receiving a command/signal from the software of the automated clinical analyzer, the motor 54 is actuated, thereby raising the peg 40 the appropriate vertical distance.

In addition to comprising the motor 54, the indicator moving mechanism 50 comprises a lead screw 56. The motor 54 functions to drive the lead screw 56 vertically upwards or vertically downwards. A motor 54 that is suitable for driving the lead screw 56 is a stepper motor. A stepper motor suitable for use herein is commercially available from Haydon Switch and Instrument, Waterbury, Conn., under the designation Linear Actuator Series. The specifications of such a stepper motor include 20 mm diameter, 5 volts, 270 mA, and 2.7 watts. The lead screw 56 is built into the motor 54. The lead screw 56 has an upper end 56a upon which is mounted a push rod 58. The push rod 58 pushes the movable peg 40 when the sample rack 30 is located at a particular location on the plate 52. A push rod 58 suitable for use herein is a stainless steel bar having a diameter of approximately 0.1 inch. However, the size of the push rod 58 is not critical.

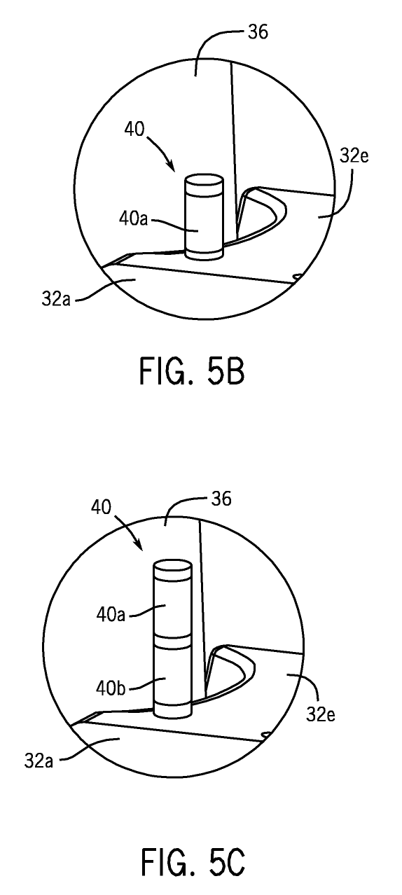

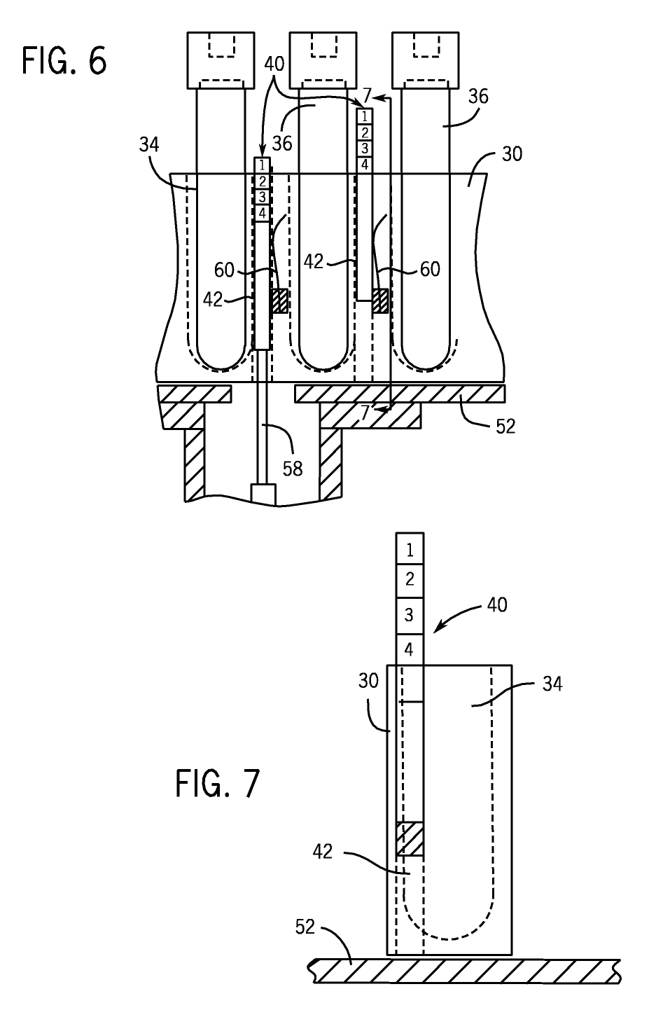

The motor 54 is actuated by means of electrical pulses transmitted from the automated clinical analyzer 10 to the motor 54. The number of revolutions of the shaft of the motor 54 is proportional to the number of electrical pulses sent to the motor 54 by the automated clinical analyzer 10. For example, in FIG. 5A, if no signal is given, the movable peg 40 is not moved. If a signal is given calling for section 40a of the movable peg 40 to be visible, the automated clinical analyzer 10 will send the motor 54 one hundred (100) electrical pulses. See FIG. 5B. If a signal is given calling for section 40b of the movable peg 40 to be visible, the automated clinical analyzer 10 will send the motor 54 two hundred (200) electrical pulses. See FIG. 5C. If section 40c of the movable peg 40 is called for, the automated clinical analyzer 10 will send the motor 54 three hundred (300) electrical pulses. If section 40d of the movable peg 40 is called for, the automated clinical analyzer 10 will send the motor 54 four hundred (400) electrical pulses. The action of the motor 54 can move the movable peg 40 to a desired height, whereat the movement of the movable peg 40 ceases through the action of a resilient biasing element 60, e.g., a spring, and friction of the resilient biasing element 60 against the interior wall of the receptacle 34, as shown in FIGS. 6 and 7. The resilient biasing element 60 merely retains the movable peg 40 at the extended position by means of friction after the push rod 58 is retracted. The resilient biasing element 60 can be formed of a metal plate or a plastic plate. The resilient biasing elements 60 can be molded into the sample rack 30 or inserted into slits formed in the sample rack 30. The direction of the motor 54 can be reversed to retract the push rod 58 as required, so that the sample rack 30 can advance to enable the next sample to be analyzed by the automated clinical analyzer 10.

After all of the analyses of the samples carried by one sample rack 30, or more than one sample rack 30, have been completed, the operator can observe the movable pegs 40 of the sample racks 30 and remove the sample tube(s) 36 from the sample rack(s) 30 wherein the movable peg(s) 40 have been displaced vertically. The operator can then introduce the sample tube(s) 36 into other sample rack(s) 30 for subsequent processing. The samples in these moved sample tubes 36 can be retested on the same automated clinical analyzer 10 with different modes of tests for specific items of interest or be retested manually. The racks 30 whose movable pegs 40 were lifted will be manually reset for reuse condition by pushing the upper portions of the movable pegs 40 down to the surface of the top wall 32e of the rack 30.

In another embodiment, an alternative indicator can be based upon optical features. For example, light-emitting diodes can be used as an indicator. Referring now to FIGS. 8, 9, 10, 11, 12, 13, 14, 15, 16, and 17, light-emitting diode(s) 70a, 70b, etc., can be positioned adjacent to each receptacle 34 of a sample rack 30. In the simplest form, the indicator can be a single light-emitting diode. Illumination of the light-emitting diode adjacent to a receptacle 34 would indicate that additional processing is required. In a more complex form, a plurality of light-emitting diodes, each light-emitting diode emitting light of a different wavelength, can be placed adjacent to each receptacle 34. When required, a plurality of signals can be generated, thereby enabling more complex instructions for additional processing. For example, the use of a red light-emitting diode 70a and a green light-emitting diode 70b would enable the retention of four different instructions. The instructions are indicated by the following combinations: both lights off, both lights on, red light off and green light on, green light off and red light on. Examples of instructions that can be handled by a system utilizing two light-emitting diodes include, for example, (1) sample processing completed, (2) blood smear required, (3) sample rerun required, and (4) urgent action required. It should be noted that more than two light-emitting diodes can be used, but use of the additional light-emitting diodes would, of course, lead to the need for additional circuits of the type that will be described later.

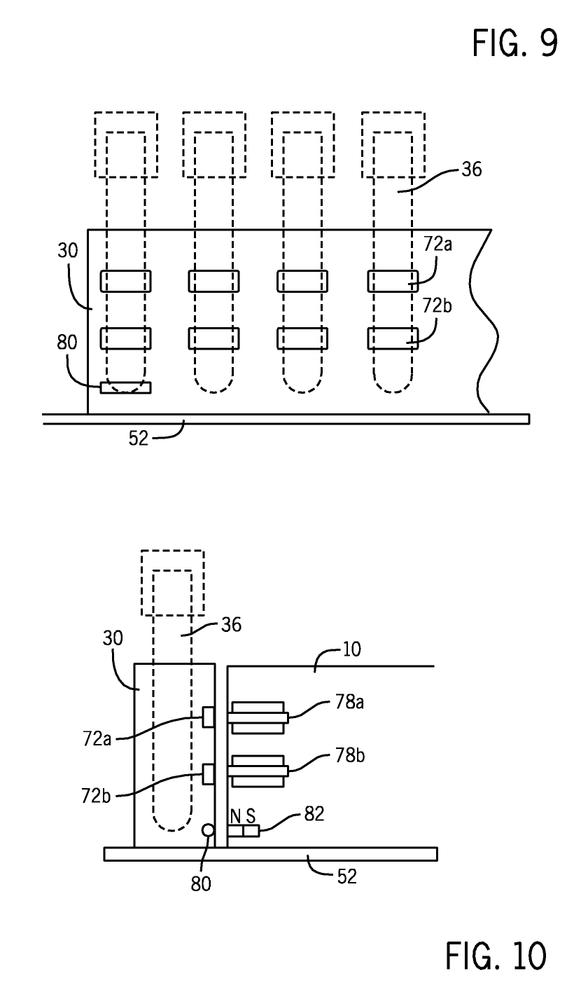

Referring now to FIGS. 9, 10, 11, 12, 13, 14, 15, 16, and 17, the light-emitting diode(s) 70a, 70b, etc., can be actuated by an electromagnetic switch mounted on the automated clinical analyzer 10 adjacent to a switching mechanism, such as, for example, reed relays and a reed switch, mounted on the sample rack 30. Upon receiving a command/signal from the software and algorithms originating from the controller/data processing module 20 of the automated clinical analyzer 10, the switching mechanism would be actuated, thereby illuminating the appropriate light-emitting diode(s) 70a, 70b, etc. The switching mechanism is actuated by signals that are sent to electromagnetic rods by electromagnetic rod drive circuits, which will be described later. Each sample tube position on the sample rack 30 has one red light-emitting diode 70a, one green light-emitting diode 70b, a reed relay 72a for the red light-emitting diode 70a, a reed relay 72b for the green light-emitting diode 70b, a resistor 74a in the circuit containing the red light-emitting diode 70a, a resistor 74b in the circuit containing the green light-emitting diode 70b, a switch 76a in the circuit containing the red light-emitting diode 70a, and a switch 76b in the circuit containing the green light-emitting diode 70b. For example, if a sample rack 30 has ten receptacles 34, then ten red light-emitting diodes 70a, ten green light-emitting diodes 70b, twenty reed relays 72a, 72b, twenty resistors 74a, 74b, and twenty switches 76a, 76b are employed per sample rack.

For the sake of simplification, the components and circuitry for only one sample tube position will be numbered. However, it is to be understood that the components and operations of the remainder of the sample tube positions function in the same manner as do the components and operations of the sample tube position described. Furthermore it should be noted that the colors of the light emitted by the light-emitting diodes can be other than red and green.

In the sample rack 30 are built two reed relays 72a, 72b at each sample tube position, such as, for example, one reed relay 72a for the red light-emitting diode 70a and one reed relay 72b for the green light-emitting diode 70b at each sample tube position. Each reed relay 72a, 72b at a given sample tube position can be actuated by an external electromagnetic field generated by an electromagnetic rod 78a, 78b, respectively, positioned on the automated clinical analyzer 10. The external electromagnetic field is generated for only short period of time, for example, one second, and the appropriate reed relay(s) 72a, 72b at each sample tube position is latched with the electronic circuits of the sample rack 30 and the internal power supply of the sample rack 30 until a reed switch 80 for resetting the reed relay(s) 72a, 72b is actuated. The light-emitting diode(s) 70a, 70b at each tube position is actuated by electronic latching circuits, which are described later, and the light of the light-emitting diode(s) 70a, 70b at each sample tube position is maintained until the reed switch 80 for resetting the reed relay(s) 72a, 72b at each sample tube position is actuated. One of the two electromagnetic rods 78a is facing the reed relay(s) 72a, and the other of the two electromagnetic rods 78b is facing the reed relay(s) 72b, so that each electromagnetic rod 78a, 78b can radiate its magnetic field towards its counterpart reed relay 72a, 72b, respectively. The two electromagnetic rods 78a, 78b are preferably located at or near the sample aspiration station 18 so that there is no cross interference between the electromagnetic rod 78a and the reed relay 72b of the green light-emitting diode 70b and no cross interference between the electromagnetic rod 78b and the reed relay 72a of the red light-emitting diode 70a.

A reed relay is a latching relay, which has two relaxed states (bistable). These are also called ‘keep’ relays. When the current is switched off, the relay remains in its last state. This effect can be achieved with a solenoid operating a ratchet and cam mechanism, or by having two opposing coils with an over-center spring or permanent magnet to hold the armature and contacts in position while the coil is relaxed, or with a remnant core. In the ratchet and cam example, the first pulse to the coil turns the relay on and the second pulse turns it off. In the two coil example, a pulse to one coil turns the relay on and a pulse to the opposite coil turns the relay off. This type of relay has the advantage that it consumes power only for an instant, while it is being switched, and it retains its last setting across a power outage.

The reed switch 80 in the sample rack 30 is used for resetting all latched reed relays 72a, 72b for all of the sample tube positions in the sample rack 30. The reed switch 80 is actuated by the application of a magnetic force thereto before the sample rack 30 travels into the aspiration station 18 of the automated clinical analyzer 10. The magnetic force for actuating the reed switch 80 for resetting the latched reed relays 72a, 72b in all of the sample tube positions is generated by means of a permanent magnet 82 located at a distance of approximately one receptacle width upstream of the sample aspiration station 18. The reed switch 80 functions as a shut-off switch to shut off current flowing to the reed relays 72a, 72b at all of the sample tube positions, so that all of the reed relays 72a, 72b in the sample rack 30 are returned to the unlatched condition.

Referring now to FIGS. 14, 15, 16, and 17, one lead wire from each light-emitting diode 70a, 70b at each sample tube position is connected to a resistor 74a, 74b, respectively, and another lead wire from each light-emitting diode 70a, 70b is connected to a contact 84a, 84b, respectively, of the reed relay 72a, 72b, respectively, at each sample tube position. When a given contact 84a, 84b at a given sample tube position is closed, the lead wire from the positive terminal of the power source 86 is connected to the light-emitting diode 70a, 70b, respectively, and the other lead wire of the resistor 74a, 74b, respectively, is connected to the zero voltage terminal (negative terminal) of the power source 86. Each light-emitting diode 70a, 70b at a given sample tube position is actuated when the appropriate reed relay 72a, 72b, respectively, at the given sample tube position is latched and remains actuated until reset.

Referring to FIG. 14, a total of twenty (20) reed relays 72a, 72b, etc., are employed in the sample rack 30, with one reed relay 72a for each red light-emitting diode 70a and one reed relay 72b for each green light-emitting diode 70b, being located at each sample tube position on the sample rack 30. One reed switch 80 is located at the position of the first sample tube. The reed relays 72a, 72b, etc., and the reed switch 80 are installed close to the surface of a side of the sample rack 30 so that the magnetic field from the electromagnetic rods 78a, 78b, and the magnetic field from the permanent magnet 82 can reach the reed relays 72a, 72b, etc., and the reed switch 80, to actuate the reed relays 72a, 72b, etc., and the reed switch 80, respectively, as required. The two electromagnetic rods 78a, 78b and the one permanent magnet 82 are mounted upon or close to a side wall of the automated clinical analyzer 10 facing the surface of a side of the sample rack 30 so that the magnetic field from the electromagnetic rods 78a, 78b and the magnetic field from the permanent magnet 82 can reach the reed relays 72a, 72b, etc., and the reed switch 80, respectively.

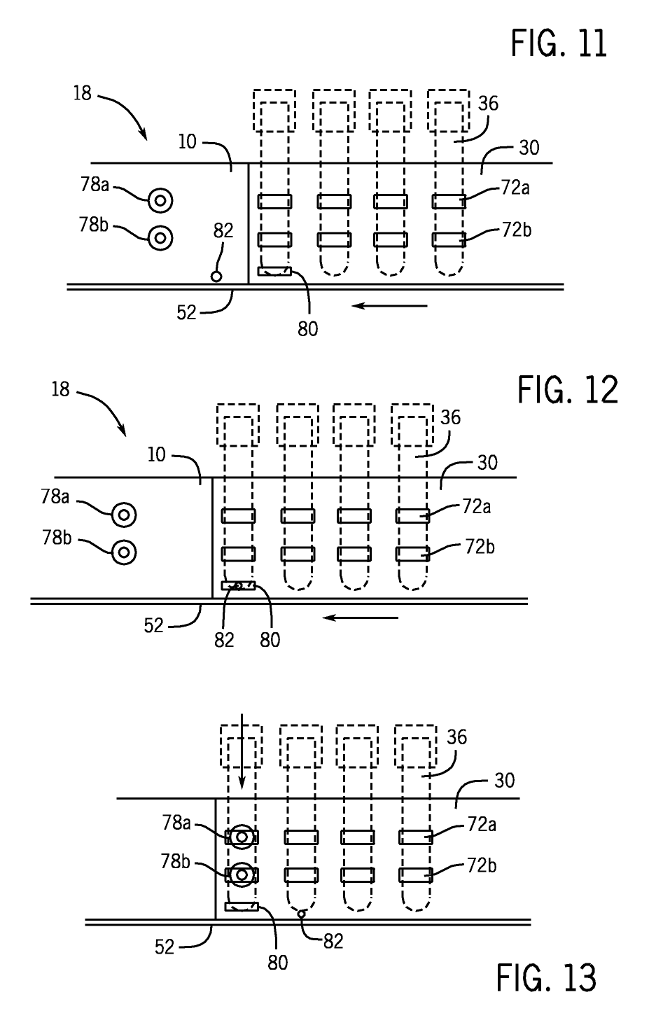

FIGS. 11, 12, and 13 are sequential illustrations that explain how reed relays 72a, 72b, etc., are latched and the information (binary state) is maintained in the reed relays 72a, 72b, etc. For the sake of simplification, the verbiage describing the operation of the electromagnetic rods 78a, 78b, the reed relays 72a, 72b, etc., the light-emitting diodes 70a, 70b, etc., will be set in the singular, i.e., as if only one electromagnetic rod, one reed relay, and one light-emitting diode is actuated. However, it should be understood that both electromagnetic rods 78a, 78b, both reed relays 72a, 72b of each sample tube position, and both light-emitting diodes 70a, 70b of each sample tube position can be actuated at the same time.

Referring now to FIG. 11, the sample rack 30 has not arrived at the position where resetting all reed relays 72a, 72b, etc., of the sample rack 30 occurs. The electromagnetic rods 78a, 78b are located at the sample aspiration station 18. The permanent magnet 82 is located at a distance that is equivalent to one receptacle width upstream of the aspiration station 18, so that all prior states of the light-emitting diodes 70a, 70b, etc., can be reset before the sample rack 30 is advanced to the sample aspiration station 18. The sample rack 30 is moving from right to left in FIG. 11.

FIG. 12 shows the sample rack 30 in a position where all prior states of light-emitting diodes 70a, 70b, etc., are reset in order to receive a new status at the sample aspiration position.

FIG. 13 shows the sample rack 30 in a position where the first sample tube is at the aspiration station 18. If the automated clinical analyzer 10 determines that the sample at the aspiration station 18 should be rerun, reviewed manually, that there is a short sample, i.e., the volume of the sample is insufficient to provide reliable results, or that there is some other indication of an error, an electromagnetic rod(s) 78a, 78b is energized by the electronics of the automated clinical analyzer 10, and the appropriate status of a light-emitting diode(s) 70a, 70b at the sample tube position is set accordingly. The appropriate reed relay(s) 72a, 72b is latched with the internal electric circuit built into the sample rack 30 so that the appropriate light-emitting diode(s) 70a, 70b is actuated, and the status of the appropriate light-emitting diode(s) 70a, 70b remains until the reed relay(s) 72a, 72b is reset.

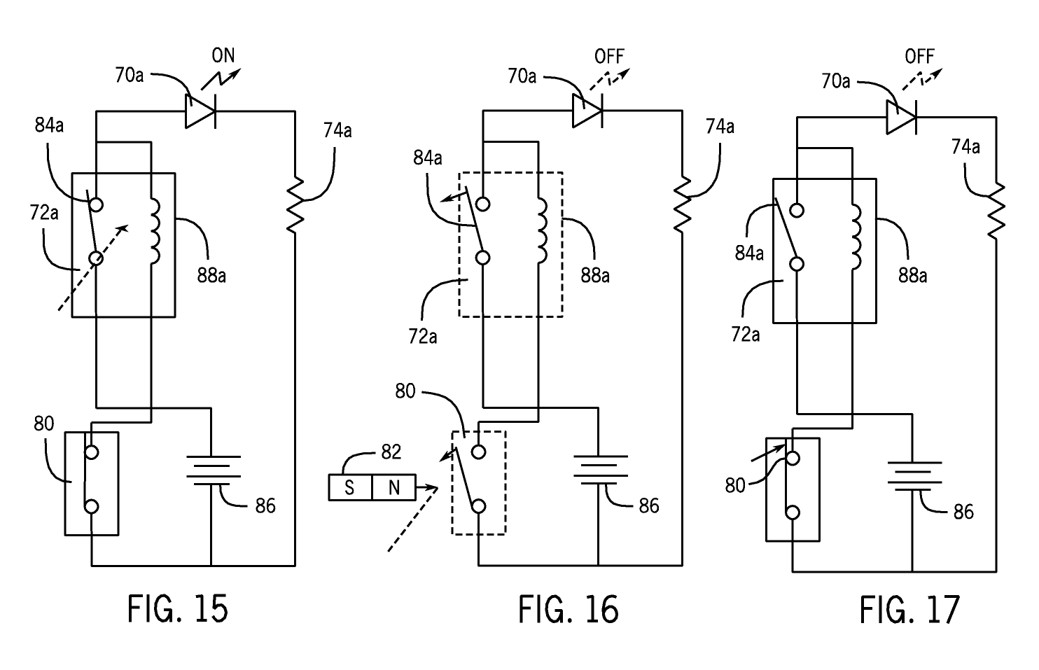

In order to operate the circuitry for the light-emitting diodes, as shown in FIGS. 14, 15, 16, and 17, the automated clinical analyzer 10 generates a pulse 100 to actuate a transistor 102 for one second, thereby energizing the appropriate electromagnetic rod(s) 78a, 78b and generating a magnetic field, which reaches the appropriate reed relay(s) 72a, 72b in a given sample tube position in the sample rack 30. The appropriate reed relay(s) 72a, 72b in the given sample tube position is sufficiently excited with the magnetic field, thereby closing the appropriate contact(s) 84a, 84b in the appropriate reed relay(s) 72a, 72b. When the appropriate contact(s) 84a, 84b is closed, electric current from the power source 86 begins flowing through the appropriate contact(s) 84a, 84b and the appropriate relay coil(s) 88a, 88b in the appropriate reed relay(s) 72a, 72b, whereby the magnetic field of the appropriate relay coil(s) 88a, 88b maintains the appropriate contact(s) 84a, 84b closed after the appropriate electromagnetic rod(s) 78a, 78b has become de-energized, i.e., after the external magnetic field has been removed. In each sample tube position, the anode of the light-emitting diode(s) 70a, 70b is connected to one side of the contact(s) 84a, 84b, respectively, of the reed relay(s) 72a, 72b, respectively, and the cathode of the light-emitting diode(s) 70a, 70b is connected to one side of the resistor(s) 74a, 74b, respectively. Because the contact(s) 84a, 84b of the reed relay(s) 72a, 72b, respectively, is connected to the positive terminal of the power source 86 and the resistor(s) 74a, 74b is connected to negative terminal of the power source 86, the light-emitting diode(s) 70a, 70b in a given sample tube position is able to be actuated. See FIGS. 14 and 15. The resistor(s) 74a, 74b is selected to enable current ranging from 5 to 10 mA to flow through the light-emitting diode(s) 70a, 70b. The voltage of the power source 86 is typically about 3 volts. The power source 86 can be, for example, a supercapacitor, a rechargeable battery, a long-life lithium battery, which can be built into the sample rack 30.

FIGS. 14 and 15 show the permanent magnet 82 in the automated clinical analyzer 10 and the reed switch 80 in the sample rack 30. All the coils 88a, 88b, etc., of all the reed relays 72a, 72b, etc., respectively, are connected to the reed switch 80. The reed switch 80 is normally closed, which means that the reed switch 80 is closed when the permanent magnet 82 is not near the reed switch 80, and the reed switch 80 opens its circuit when the permanent magnet 82 is near the reed switch 80. See FIGS. 15 and 16. The reed switch 80 is used to reset all latched reed relays 72a, 72b, etc., to the unlatched condition, and to turn off all light-emitting diode(s) 70a, 70b, etc. See FIG. 17. The sample rack 30 described herein can be reused after the status of light-emitting diode(s) 70a, 70b, etc., and reed relay(s) 72a, 72b, etc., are reset. The reed switch 80 can be triggered with either permanent magnet 82 built into the automated clinical analyzer 10 and/or an individual magnet manually.

In FIG. 16, electric current flowing through a relay coil(s) 88a, 88b, etc., and a light-emitting diode(s) 70a, 70b, etc., is shut off by the reed switch 80. The reed relay(s) 72a, 72b, etc., becomes de-energized and the contact(s) 84a, 84b, etc., opens. In FIG. 17, when the reed switch 80 passes over the location of the magnet 82, the contact of the reed switch 80 closes again. Because the reed relay(s) 72a, 72b, etc., has already become de-energized, electric current from the power source 86 would not flow anywhere. The reed relay(s) 72a, 72b, etc., is unlatched or reset and the light-emitting diode(s) 70a, 70b, etc., is turned off.

Only one reed switch 80 is required to reset all reed relays 72a, 72b, etc., and light-emitting diode(s) 70a, 70b, etc., in one sample rack 30. By one motion of the reed switch 80, all reed relays 72a, 72b, etc., can be returned to the “off” or “reset” condition. One power source 86 is commonly used for the entire circuit in one sample rack.

Power sources 86 suitable for use herein include supercapacitors, rechargeable batteries, and long-life batteries. Supercapacitors can store large amounts of electric energy with the aid of inductance charging method. If a rechargeable battery is used, a battery charger is required to recharge the rechargeable battery. A rechargeable battery requires several hours to be recharged completely. If a supercapacitor is used, a power induction loop (alternatively referred to herein as an induction coil) can be built into the automated clinical analyzer 10. This power induction loop can be located upstream of the sample aspiration position 18, because a supercapacitor can be charged within approximately ten seconds. Inductive charging is a method of charging an electrical battery (or a supercapacitor) without the need for direct electrical contact between the battery (or the supercapacitor) and the charger. Inductive charging uses electromagnetic induction, whereby a charging station induces a current inside an adjacent electrical device, which transfers power to the battery (or the supercapacitor). Induction chargers typically use an induction coil to generate an alternating electromagnetic field from within a charging base station, e.g., an automated clinical analyzer 10, and a second induction coil in the portable device, e.g., a sample rack 30, takes power from the electromagnetic filed and converts it back into electrical current to charge the battery (or the supercapacitor). The two induction coils in close proximity combine to form an electrical transformer. Inductive charging has the advantage that the contacts of the battery (or the supercapacitor) can be completely sealed to prevent exposure to water. Alternatively, a supercapacitor can be charged by means of a charging apparatus external to the automated clinical analyzer 10, in which case a power induction loop need not be built into the automated clinical analyzer 10. Regardless of the type of power source used, the purpose of the power source located in the sample rack 30 is to maintain the signaling status of the reed relay(s) 72a, 72b.

In another embodiment, an induction system can be used to actuate light-emitting diode(s) 70a, 70b, etc., to signal to an operator the status of a sample, e.g., rerun the sample, perform manual review, a short sample. Referring now to FIGS. 18 and 21, and like the previous embodiment described, light-emitting diode(s) 70a, 70b, etc., can be positioned adjacent to each receptacle 34 of a sample rack 30. In the simplest form, the indicator can be a single light-emitting diode. Illumination of the light-emitting diode adjacent to a receptacle 34 would indicate that additional processing is required. In a more complex form, a plurality of light-emitting diodes, each light-emitting diode emitting light of a different wavelength, can be placed adjacent to each receptacle 34. When required, a plurality of signals can be generated, thereby enabling more complex instructions for additional processing. For example, the use of a red light-emitting diode 70a and a green light-emitting diode 70b would enable the retention of four different instructions. The instructions are indicated by the following combinations: both lights off, both lights on, red light off and green light on, green light off and red light on. Examples of instructions that can be handled by a system utilizing two light-emitting diodes include, for example, (1) sample processing completed, (2) blood smear required, (3) sample rerun required, and (4) urgent action required. It should be noted that more than two light-emitting diodes can be used, but use of the additional light-emitting diodes would, of course, lead to the need for additional circuits.

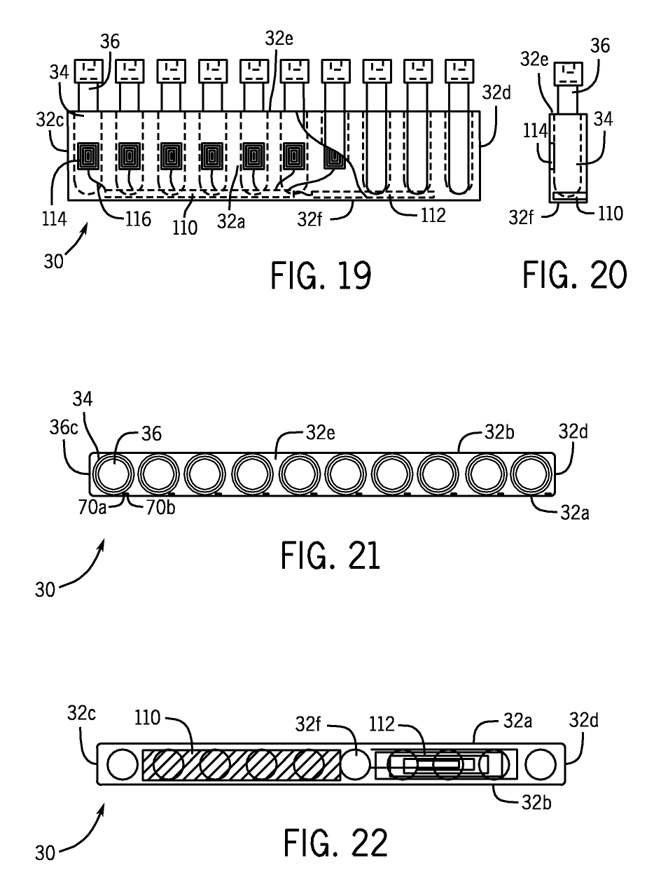

Electronic and electrical components that drive the light-emitting diode(s) 70a, 70b, etc., are also mounted inside, i.e., embedded in, the sample rack 30. The electronic and electrical components 110 comprise a power source for supporting all electronic components that have been energized, an analog to digital signal converter for decoding radio frequency signals to digital codes, a memory circuit for storing the status of each sample, and a light-emitting diode driver circuit for driving the light-emitting diodes 70a, 70b, etc. A first induction coil (not shown) is located in the automated clinical analyzer 10 and a second induction coil 112 is located in the sample rack 30. The power source is typically a supercapacitor (not shown) and appropriate circuitry (not shown) exists to enable charging of the supercapacitor by means of the second induction coil 112. At least one memory (not shown) stores the information relating to each sample tube 36. A pick-up coil 114, e.g., a radio frequency identification tag, is positioned at each sample tube position of the sample rack 30 to obtain information relating to each individual sample tube 36. As shown in FIGS. 19 and 20, ten pick-up coils 114 are positioned in each sample rack 30 because each sample rack 30 has ten sample tube positions, i.e., receptacles 34. The pick-up coils 114 receive signals sent from a transmitter coil (not shown) attached to the automated clinical analyzer 10 at a position downstream of the sample aspiration position 18. Wires 116 carry the signal from the pick-up coils 114 to the electronic and electrical circuits located with the electronic and electrical components 110. The analog signals can be radio frequency signals.

As the sample rack 30 approaches the position 18 where the sample is aspirated, an induction loop (not shown), which is located under the bottom plate 52 of the automated clinical analyzer 10, generates an alternating electromagnetic field for a pick-up coil 112 in the sample rack 30 to pick up the electromagnetic field. The alternating electromagnetic field is then converted to direct current (DC) power, which is stored in a supercapacitor (not shown) in the sample rack 30.

A transmitter coil (not shown), which is located at the sample aspiration position 18 of the automated clinical analyzer 10, sends a signal to the pick-up coil 114 at each tube position on the sample rack 30 for the memory (not shown) associated with the tube position for the sample tube 36 for which the measurement and the analysis has been completed. The signal can be generated by an electromagnetic generator, which comprises a generator capable of generating a radio frequency, alternating current signal. The signal is generated by software and algorithms originating from the controller/data processing module 20 of the automated clinical analyzer 10. Electrical circuits in the sample rack 30 decode the alternating current into a form to reflect the status of the particular sample and actuate the appropriate light-emitting diode(s) 70a, 70b. The memory retains the information until the contents are cleared. Such information typically includes, but is not limited to, request rerun in resistant red cell test mode, request a manual review, or indicate that a sample quantity is not sufficient for performing a test (short sample). The supercapacitor in the sample rack 30 can be selected to supply sufficient electrical power to the electronic devices in the sample rack 30 to enable the light-emitting diode(s) 70a, 70b, etc., to run for a period of up to 48 hours.

When the pick-up coil 112 receives a reset signal from an induction loop (not shown), which is located at a fixed position immediately upstream of the sample aspiration position 18 of the automated clinical analyzer 10, the reset signal clears the at least one memory to set the condition of the sample rack 30 for reuse.

Power sources suitable for use with the aforementioned embodiment include supercapacitors, rechargeable batteries, and long-life batteries of the type described previously with respect to the embodiment shown in FIGS. 14, 15, 16, and 17. Regardless of the type of power source used, the purpose of the power source located in the sample rack 30 is to maintain the signaling status of the light-emitting diodes 70a, 70b, etc.

In FIGS. 19 and 21, a first induction coil (not shown) is in the automated clinical analyzer 10 and a second induction coil 112 is in the sample rack 30. The power source is typically a supercapacitor (not shown) and appropriate circuitry (not shown) exists to enable charging of the supercapacitor by means of the second induction coil 112.

In still another embodiment, as shown in FIGS. 23, 24, 25, 26, 27, 28, and 29, a dedicated sample rack reader 120 can be employed to read the information associated with each sample tube 36 in the sample rack 30. Instead of one or more light-emitting diodes being adjacent to the receptacle 34 in the sample rack 30, the sample rack 30 has a radio frequency transponder 114 adjacent to each receptacle 34. The sample rack 30 further comprises a radio frequency transmitter coil 122, which is located near the bottom of the sample rack 30.

Like the previous embodiment described, as the sample rack 30 approaches the position 18 where the sample is aspirated, an induction loop (not shown), which is located under the bottom plate 52 of the automated clinical analyzer 10, generates an alternating electromagnetic field for a pick-up coil 112 in the sample rack 30 to pick up the electromagnetic field. The alternating electromagnetic field is then converted to direct current (DC) power, which is stored in a supercapacitor (not shown) in the sample rack 30. Again, like the previous embodiment described, a transmitter coil (not shown), which is located at the sample aspiration position 18 of the automated clinical analyzer 10, sends a signal to the pick-up coil 114 at each tube position on the sample rack 30 for the memory (not shown) associated with the tube position for the sample tube 36 for which the measurement and the analysis has been completed. The signal is generated by software and algorithms originating from the controller/data processing module 20 of the automated clinical analyzer 10. The memory retains the information until the contents are cleared. Such information typically includes, but is not limited to, request rerun in resistant red cell test mode, request a manual review, or indicate that a sample quantity is not sufficient for performing a test (short sample).

The radio frequency transmitter coil 122 transmits the signal to the dedicated sample rack reader 120, which is equipped with a receiver loop 124 under a tray 126 to receive a signal from each sample rack 30. More than one sample rack 30 can be placed on the dedicated sample rack reader 120. The dedicated sample rack reader 120 has a display screen 128, where identification numbers of the sample racks 30, images 130 of the sample racks 30 on the tray 126, e.g., circles representing each sample tube location, are depicted. The images 130 can be formed by a liquid crystal display. The images 130 formed by the liquid crystal display inform the operator what retest mode(s), if any, should be used for the particular sample tubes 36 identified. The images can be of different colors, each color representing a different instruction. The operator removes these sample tubes 36, which are identified by images on the display, and places them in one sample rack 30 for rerun in a specific test mode, or sends them to another location for manual slide review. In order to aid the operator in using the dedicated sample rack reader 120, line markers 132 for alignment of sample racks 30 are formed on the visible surface of the tray 126 and marking numbers 134 for identification of sample racks 30 are formed on the visible surface of the tray 126. The dedicated sample rack reader also includes a radio frequency pick-up coil 124 for receiving signals from the sample rack 30 and a power induction coil 138 for supplying electrical power to the sample rack 30 on the tray 126 of the dedicated sample rack reader 120.

Again, like the previous embodiment described, when the pick-up coil 112 receives a reset signal from the aforementioned induction loop (not shown), which is located at a fixed position immediately upstream of the sample aspiration position 18 of the automated clinical analyzer 10, the reset signal clears the at least one memory to set the condition of the sample rack 30 for reuse.

Power sources suitable for use with the aforementioned embodiment include supercapacitors, rechargeable batteries, and long-life batteries of the type described previously with respect to the embodiment shown in FIGS. 14, 15, 16, and 17. Regardless of the type of power source used, the purpose of the power source located in the sample rack 30 is to maintain the signaling status of the memories and to transmit the status to the pick-up coil 124 on the tray 126.

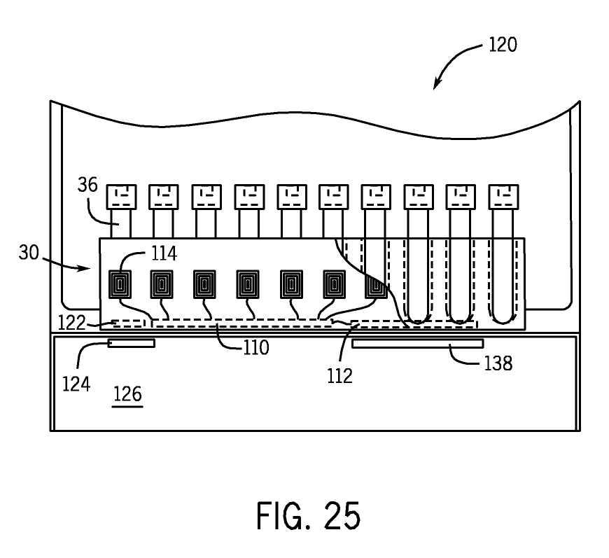

In FIGS. 25, 26, and 29, a first induction coil (not shown) is in the automated clinical analyzer 10 and a second induction coil 112 is in the sample rack 30. The power source is typically a supercapacitor (not shown) and appropriate circuitry (not shown) exists to enable charging of the supercapacitor by means of the second induction coil 112.

In still another alternative embodiment, the sample tubes 36 contained by the sample rack 30 can be associated with a reader capable of detecting a signal by means of wireless detection. For example, a wireless handheld device (not shown) capable of detecting a signal, such as, for example, a radio frequency signal, emitted from the sample rack 30. The boundary of detection of the wireless handheld device would allow a directional finding of a particular sample container 36 in its position in the sample rack 30. Through the use of an inducible and programmable signal in the sample rack 30, additional information relating to a sample tube 36 can also be read. Examples of this information can include, but need not be limited to, such information as additional processes that are required to be completed, unique specimen number, and analytical results.

By using the sample rack described herein, the operator of the clinical analyzer does not have to review a data log in order to find the identification indicia of a given sample, which may require a rerun assay or a retest. The operator does not have to search for the given sample in the sample rack.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A rack for holding at least one sample container for holding a sample, said rack comprising at least one indicator, which indicator indicates whether said sample in said sample container requires retesting.

2. The rack of claim 1, wherein said rack holds a plurality of sample containers, each sample container for holding a sample.

3. The rack of claim 1, wherein said indicator comprises at least one movable peg.

4. The rack of claim 1, wherein said indicator comprises at least one light-emitting diode.

5. The rack of claim 1, wherein said indicator comprises a liquid crystal display.

6. A system for indicating whether a sample requires additional processing, said system comprising:
(a) a rack for holding at least one sample container for holding a sample, said rack comprising at least one indicator, which indicator indicates whether said sample in said sample container requires retesting; and
(b) assembly for causing said indicator to change to indicate the need for a retest.

7. The system of claim 6, wherein said indicator comprises at least one movable peg, and indication of a requirement for additional processing is indicated by change of position of said at least one peg.

8. The system of claim 6, wherein said indicator comprises at least one light-emitting diode, and said indication of a requirement for additional processing is shown by activation of said at least one light-emitting diode.

9. The system of claim 6, wherein said indicator comprises a liquid crystal display, which transmits a signal to indicate a requirement for additional processing.

10. A method for determining whether a sample in a sample container in a rack requires a retest, said method comprising the steps of:
(a) providing the system of claim 6;
(b) running at least one test on said sample in said sample container;
(c) obtaining a result from the at least one test; and
(d) observing whether the indicator indicates that a retest is required.

11. The method of claim 10, wherein said indicator comprises at least one movable peg, and indication of a requirement for additional processing is indicated by change of position of said at least one peg.

12. The method of claim 10, wherein said indicator comprises at least one light-emitting diode, and said indication of a requirement for additional processing is shown by activation of said at least one light-emitting diode.

13. The method of claim 10, wherein said indicator comprises a liquid crystal display, which transmits a signal to indicate a requirement for additional processing.
